(19) United States
(12) Patent Application Publication
(10) Pub. No.: US 2026/0140480 A1
(43) Pub. Date: May 21, 2026

(54) QUICK CORRECTION DEVICE WITH LEVER FOR A HOROLOGY MOVEMENT

(71) Applicant: Montres Breguet S.A., L'Abbaye (CH)

(72) Inventor: Pascal FRIDERICI, L'Orient (CH)

(73) Assignee: Montres Breguet S.A., L'Abbaye (CH)

(21) Appl. No.: 19/355,091

(22) Filed: Oct. 10, 2025

(30) Foreign Application Priority Data
Nov. 19, 2024 (EP) 24214016.8

(51) Int. Cl. G04B 27/02; G04B 19/24

(52) U.S. Cl. CPC G04B 27/02; G04B 19/24

(57) ABSTRACT

A device (1) for correcting an indication provided by a display mechanism for a horology movement fitted with a display mechanism including an indicator wheel (2), the actuation of the indicator wheel (2) making it possible to change the display indication. The correction device (1) includes a correction organ (3) that is mobile between two positions around a rotational pivot (12), a locked position and a correction position, the correction organ (3) being configured to turn the indicator wheel (2) when the correction organ (3) is in the correction position, and a rotationally mobile lever (5) including a first end (23) configured to press against the correction organ (3) to move it from the locked position to the correction position. Also, a horology movement including such a correction device (1).

### CROSS-REFERENCE TO RELATED APPLICATIONS

This application claims priority to European Patent Application No. 24214016.8 filed on November 19, 2024, the entire contents of which are incorporated herein by reference.

### FIELD OF THE INVENTION

The invention relates to a quick correction device with a lever for a horology movement comprising a display mechanism.

The invention also relates to a horology movement comprising such a correction device.

The invention relates to the field of horology, and more specifically to timepieces comprising a display mechanism.

### BACKGROUND OF THE INVENTION

This invention relates to watches that require a device for quickly correcting certain functions (date, day, month, or other), in particular display functions such as a date (simple, annual, perpetual, day/date, or other), or moon phase, tide, AM/PM displays, or other indicators. A particular example of an annual date mechanism is described in patent EP1666991B1 held by ETA SA.

To correct the date without a quick correction mechanism using the winding stem or the button incorporated into the watchcase, the user has to make a correction via the date. In the worst cases, this can be a long and tedious process. He may have to make a 30-day correction. Similarly, if the user makes a mistake during the correction, the operation has to be repeated. Making the correction via the date drive mechanism could lead to excessive use and potentially cause malfunctions.

To actuate an indicator wheel, correction devices often have levers, which are essential components in horology mechanisms that enable a mechanism to be switched between several different modes, usually between two specific positions. One of the positions actuates the rotation of the indicator wheel. A horology lever is often accompanied by a return spring to ensure that the movement is correctly transmitted or positioned, as the case may be.

The correction device generally consists of a train consisting of one or several components and actuated from the winding stem.

However, such a correction device takes up space in the movement and often requires numerous components, particularly when the indicator wheel is away from the winding stem.

A common alternative is to use buttons incorporated into the watchcase. However, this alternative is often relatively expensive and can cause problems with the water-resistance of the watchcase.

### SUMMARY OF THE INVENTION

The present invention aims to remedy the aforementioned drawbacks of the prior art and to enable the user to make a quick correction to a display mechanism, and more specifically to a date mechanism.

To this end, the invention relates to a device for correcting an indication provided by a display mechanism for a horology movement fitted with a display mechanism comprising an indicator wheel, the actuation of the indicator wheel making it possible to change the display indication.

The correction device is remarkable in that it further comprises a correction organ between two positions, a locked position and a correction position, the correction organ being configured to turn the indicator wheel when the correction organ is in the correction position, and a rotationally mobile lever comprising a first end configured to press against the correction organ to move it from the locked position to the correction position.

A correction organ can therefore be arranged near the indicator wheel and actuated remotely with the lever. The invention ensures that the correction device takes up less space and is easier to incorporate into a horology movement, as this system allows the correction function to be transferred over a great distance.

According to a particular embodiment of the invention, the correction device comprises a cam mobile for engaging with the lever to actuate the correction organ when the cam mobile is actuated.

According to a particular embodiment of the invention, the lever comprises a second end with two arms, an actuating arm comprising an actuating beak and a pivot arm enabling the lever to pivot when it is actuated.

According to a particular embodiment of the invention, the two arms at least partially delineate a space between them.

According to a particular embodiment of the invention, the two arms are curved around said space.

According to a particular embodiment of the invention, the cam mobile is arranged in the space.

According to a particular embodiment of the invention, the two arms are made in one piece; preferably the lever is made in one piece.

According to a particular embodiment of the invention, the cam mobile is fitted with teeth configured to push the actuating beak of the lever actuating arm.

According to a particular embodiment of the invention, the correction device comprises a winding stem configured to actuate the cam mobile, and thereby the lever.

According to a particular embodiment of the invention, the correction organ comprises a jumper arm configured to position the indicator wheel and keep it from turning in the event of a shock, when the correction organ is in the locked position.

According to a particular embodiment of the invention, the correction organ comprises a correction arm configured to push the indicator wheel when the correction organ is in the correction position.

According to a particular embodiment of the invention, the jumper arm and the correction arm are at least partially arranged on either side of the indicator wheel.

According to a particular embodiment of the invention, the jumper arm and the correction arm are arranged so that together they form a substantially U-shape.

According to a particular embodiment of the invention, the jumper arm and the correction arm are made in one piece.

According to a particular embodiment of the invention, the correction arm is arranged between the indicator wheel and the lever.

According to a particular embodiment of the invention, the correction device comprises a spring exerting a return force on the correction organ to return the correction organ from the correction position to the locked position.

According to a particular embodiment of the invention, the correction device extends substantially in the same plane.

According to a particular embodiment of the invention, the display mechanism is a moon phase display or a date display or a day display or a month display or a tide display or a time zone display.

The invention also relates to a horology movement comprising such a correction device.

### BRIEF DESCRIPTION OF THE DRAWINGS

Other characteristics and advantages of the invention will become apparent from the detailed description below, with reference to the accompanying drawings, in which:

FIG. 1 shows a schematic perspective view of an embodiment of a correction device according to the invention,

FIG. 2 shows a schematic view of the underside of the correction device shown in FIG. 1,

FIG. 3 shows a schematic top view of the correction device in FIG. 1, when the correction organ is in the locked position,

FIG. 4 shows a schematic top view of the correction device in FIG. 1 when the correction organ is in the correction position for engaging with the indicator wheel, and

FIG. 5 shows part of a horology movement comprising the correction device.

### DETAILED DESCRIPTION OF PREFERRED EMBODIMENTS

The invention relates to the field of horology mechanisms, and more specifically to movement control and transmission mechanisms. It is preferentially applied to the correction and updating of display mechanisms in a horology movement in a timepiece.

The invention relates more specifically to a device 1 for correcting an indication provided by a display mechanism in a horology movement. Preferably, the correction device 1 extends substantially in the same plane.

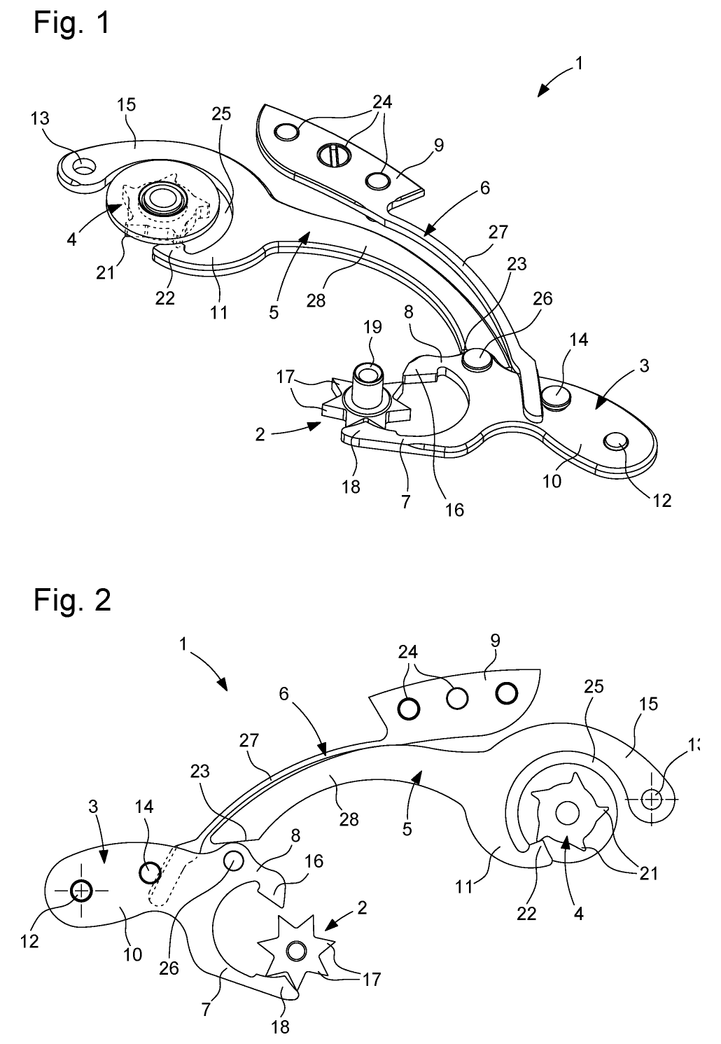

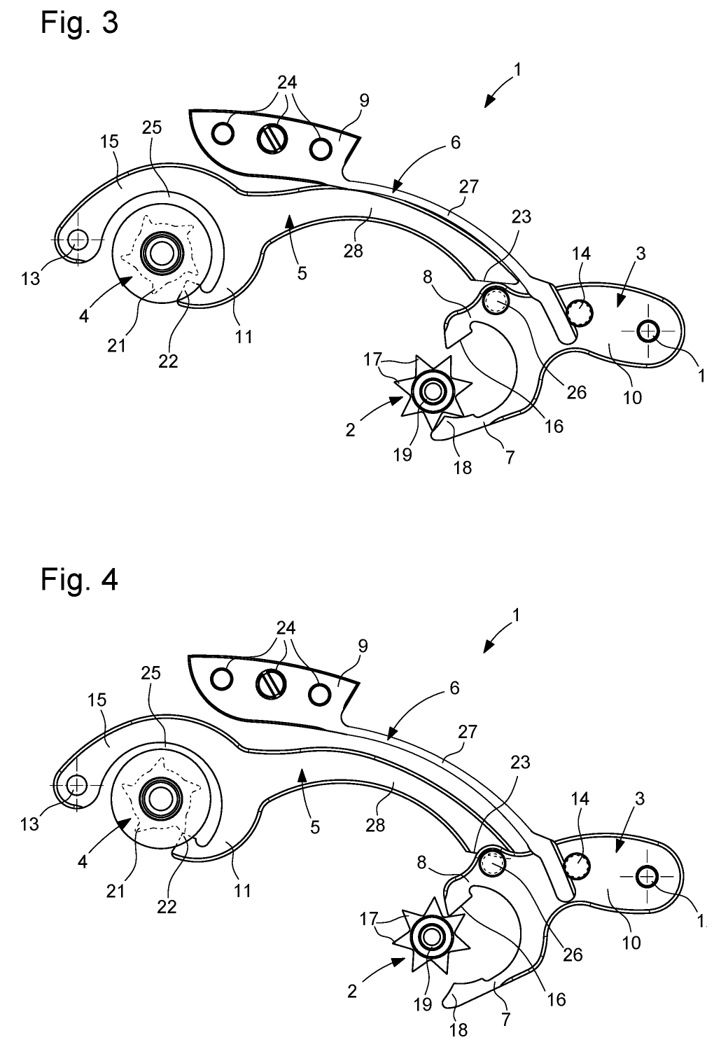

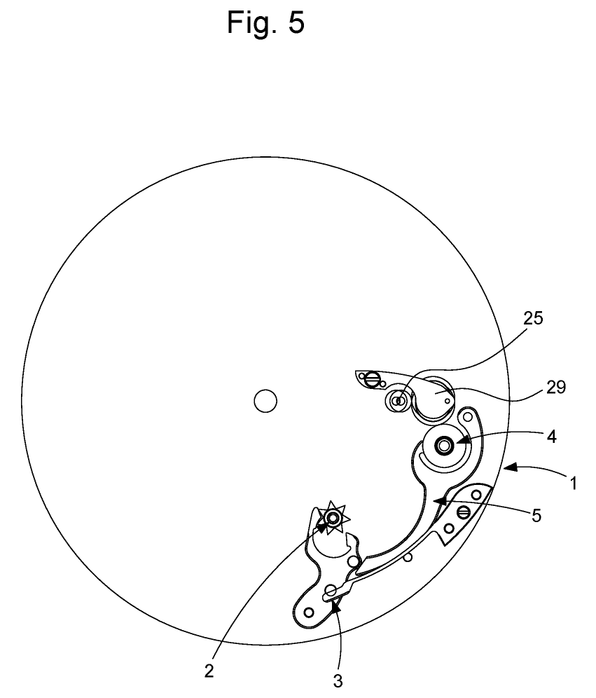

In FIGS. 1 to 5, the display mechanism comprises an indicator wheel 2 with a pipe 19. A hand, not shown in the figures, is fitted on the pipe 19 for the display, for example. The indicator wheel 2 comprises peripheral toothing 17 enabling the indicator wheel 2 to be turned.

The indicator wheel 2 is mechanically joined to the hand, and the display indication can be changed by actuating the indicator wheel 2. Preferably, the change is made step by step. Thus, for each rotation of the wheel by one notch, the display is changed by one unit.

According to the invention, the correction device 1 comprises a correction organ 3 that is rotationally mobile between two positions around a pivot 12. In a locked position, the correction organ 3 positions the indicator wheel 2 and keeps it from turning in the event of shocks. And in a correction position, the correction organ 3 engages with the indicator wheel 2 by contacting the toothing 17 to turn it. When moving from the locked position to the correction position, the correction jumper 3 rotates the indicator wheel 2 by one step.

The correction organ 3 comprises a correction arm 8 configured to actuate the indicator wheel 2 in steps when the correction organ 3 is in the correction position, and a jumper arm 7 configured to position the indicator wheel 2 and keep it from turning when the correction organ 3 is in the locked position.

The jumper arm 7 and the correction arm 8 are at least partially arranged on either side of the indicator wheel 2. For example, the jumper arm 7 and the correction arm 8 are arranged so that together they form a substantially U-shape. Thus, when the correction organ 3 moves, the correction arm 8 comes into contact with the indicator wheel 2. Preferably, the jumper arm 7 and the correction arm 8 are made in one piece.

In this example, the correction organ 3 comprises an elongated body 10 fitted with at least one blom stud 14 on its upper face. Preferably, the correction organ 3 extends in the same plane.

The correction organ 3 comprises a pivot hole 12. The hole 12 is arranged at the first end of the correction organ 3. The pivot is formed, for example, by a pin, a blom stud or a shouldered screw.

The correction arm 8 and the jumper arm 7 are arranged at the second end of the correction organ 3.

The jumper arm 7 comprises a jumper beak 18 configured to fit into the toothing 17 on the indicator wheel 2 to position it and keep it from turning.

The correction arm 3 comprises an actuating beak 16 capable of engaging in the toothing 17 on the indicator wheel 2 to turn it step by step.

When the correction organ 3 moves from the locked position to the correction position, the correction organ 3 makes a substantially rotational movement. The correction beak 16 on the correction arm 8 then pushes a tooth in the toothing 17 and turns the indicator wheel 2.

To move the correction organ 3 from the locked position to the correction position, the correction device 1 further comprises a rotationally mobile lever 5 configured to actuate the correction organ 3 to move it from the locked position to the correction position.

The lever 5 has an elongated, preferably curved shape, comprising a main arm 28 with a first end 23 forming the correction side of the lever 5, which can engage with the correction organ 3.

The lever 5 is flat and extends substantially in one plane. The lever 5 is arranged on the side with the correction arm 8 so that the correction arm 8 can be moved towards the indicator wheel 2.

Lever 5 comprises a second end with two arms 11, 15, preferably elongated. An actuating arm 11 comprises an actuating beak 22 for engaging with a cam mobile 4 and a pivot arm 15 comprising a hole 13 for a pivot around which the lever 5 can turn. The pivot is formed, for example, by a pin, a blom stud or a screw. The two arms 11, 15 are made in one piece, with the lever 5 preferably being made entirely in one piece.

The two arms 11, 15 of the lever 5 are curved, preferably concentrically, and partially delineate a space 25 in which the cam mobile 4 is arranged. In the figures, the two arms 11, 15 form substantially two-thirds of the circumference of the space 25.

A lever blom stud 26 is arranged on the correction organ 3, near the pivot point 12. When lever 5 is actuated, the correction side 23 of the lever 5 lifts the lever blom stud 26 to move the correction organ 3 from the locked position to the correction position.

The correction device 1 comprises a rotationally fitted cam mobile 4 for engaging with the lever 5, so as to push it towards the correction organ 3 when the cam mobile 4 is actuated. The cam mobile 4 is fitted with teeth 21 configured so that it can come into contact with the actuating beak 22 on the actuating arm 11 of the lever 5.

Thus, when the correction device 1 is to be used, the cam mobile 4 is actuated. The cam mobile 4 can be actuated by an actuating system, such as the first mechanism, not shown in the figures, which can comprise gears and sliding pinion assemblies. For example, the correction device comprises a winding stem, not shown in the figures, which is arranged to actuate the cam mobile 4.

The correction device 1 further comprises a spring 6 exerting a return force on the correction organ 3 to return the correction organ 3 from the correction position to the locked position. The spring 6 comprises a flexible curved blade 27 joined at one end to a heel 9, and presses against the blom stud 14 on the inside of the correction organ 3 so as to push the correction organ 3 towards the locked position. The heel 9 comprises fastening holes 24 for fastening the heel 9 to the movement, in particular for one or more pins and/or one or more screws.

Thus, when the cam mobile 4 is no longer actuated, the spring 6 pushes the correction organ 3 back from the correction position to the locked position, the correction organ 3 itself pushing the lever 5 back to its initial position.

The correction device 1 is for example incorporated into a horology movement 10 so as to correct a display such as the date, the day of the week or the month of the year. The correction is made by the user using the winding stem, not shown in the figures.

A longitudinal movement of the winding stem directly or indirectly causes an intermediate correction wheel 25 to move into a specific position (generally the intermediate position in a three-position mechanism), which meshes with a sliding pinion assembly 29 to actuate the cam mobile 4.

Turning the winding stem counterclockwise causes the intermediate correction wheel 25 to turn clockwise, the sliding pinion assembly 29 to turn counterclockwise and the cam mobile 4 to turn clockwise. The cam mobile 4 thus actuates the movement of the lever 5 against the correction organ 3 according to the method described above. The indicator wheel 2 is thus corrected in steps every time a tooth on the cam mobile lifts the lever 5.

Of course, the correction device 1 according to the invention is not limited to the embodiments described above and various simple modifications and variants can be considered by the person skilled in the art without departing from the scope of the invention as defined by the appended claims.

1. A device for correcting an indication provided by a display mechanism for a horology movement fitted with a display mechanism comprising an indicator wheel, the actuation of the indicator wheel making it possible to change the display indication, wherein the correction device comprises a correction organ that is mobile between two positions, a locked position and a correction position, the correction organ being configured to turn the indicator wheel when the correction organ is in the correction position, and a rotationally mobile lever comprising a first end configured to press against the correction organ to move it from the locked position to the correction position.

2. The correction device according to claim 1, further comprising a cam mobile for engaging the lever to actuate the correction organ when the cam mobile is actuated.

3. The correction device according to claim 2, wherein the lever comprises a second end comprising two arms, an actuating arm comprising an actuating beak for engaging with the cam mobile, and a pivot arm enabling the lever to pivot when it is actuated.

4. The correction device according to claim 3, wherein the two arms at least partially delineate a space between them.

5. The correction device according to claim 4, wherein the two arms are curved around said space.

6. The correction device according to claim 4, wherein the cam mobile is arranged in the space.

7. The correction device according to claim 3, wherein the two arms of the lever are made in one piece, the lever being made in one piece.

8. The correction device according to claim 3, wherein the cam mobile is fitted with teeth configured to push the actuating beak on the actuating arm of the lever.

9. The correction device according to claim 3, further comprising a winding stem configured to actuate the cam mobile, and thereby the lever.

10. The correction device according to claim 1, wherein the correction organ comprises a correction arm configured to push the indicator wheel when the correction organ is in the correction position.

11. The correction device according to claim 10, wherein the correction organ comprises a jumper arm configured to position the indicator wheel and keep it from turning in the event of shocks when the correction organ is in the locked position.

12. The correction device according to claim 11, wherein the jumper arm and the correction arm are at least partially arranged on either side of the indicator wheel.

13. The correction device according to claim 12, wherein the jumper arm and the correction arm are arranged so that together they form at least a partial U-shape.

14. The correction device according to claim 11, wherein the jumper arm and the correction arm are made in one piece.

15. The correction device according to claim 11, wherein the correction arm is arranged between the indicator wheel and the lever.

16. The correction device according to claim 1, further comprising a spring exerting a return force on the correction organ, to return the correction organ from the correction position to the locked position.

17. The correction device according to claim 1, wherein the display mechanism is a moon phase display or a date display or a day display or a month display or a tide display or a time zone display.

18. The correction device according to claim 1, wherein the correction device extends substantially in the same plane.

19. A horology movement comprising a device for correcting an indication provided by the display mechanism according to claim 1.
